(19) United States
(12) Patent Application Publication
(10) Pub. No.: US 2006/0209018 A1
(43) Pub. Date: Sep. 21, 2006

(54) Program product, image generation system, and image generation method

(75) Inventors: Hiroshi Watanabe, Yokohama-shi (JP); Daisuke Kise, Kyoto-shi (JP)

Correspondence Address: OLIFF & BERRIDGE, PLC, P.O. BOX 19928, ALEXANDRIA, VA, 22320, US

(73) Assignee: NAMCO LTD., Ota-ku (JP)

(21) Appl. No.: 11/117,468

(22) Filed: Apr. 29, 2005

(30) Foreign Application Priority Data
May 11, 2004 (JP) 2004-141315

(51) Int. Cl. G09G 5/00

(52) U.S. Cl. 345/156

(57) ABSTRACT

An image generation system includes: a flash image generation section which generates a flash image which increases luminance of scan light for detecting an indication position of a pointing device including a photosensor which detects scan light from a display section; a luminance adjustment processing section which displays a luminance adjustment screen for adjusting luminance of the flash image in the display section, and sets luminance adjustment information of the flash image by luminance adjustment using the luminance adjustment screen; and an image generation section which generates an image displayed in the display section. The flash image generation section generates the flash image at a luminance set by the luminance adjustment information. A luminance value of the luminance adjustment window is changed, whether or not the indication position of the pointing device is detected in the luminance adjustment window is determined, and the luminance adjustment information is set based on the luminance value at a time of detecting the indication position.

Japanese Patent Application No. 2004-141315, filed on May 11, 2004, is hereby incorporated by reference in its entirety.

### BACKGROUND OF THE INVENTION

The present invention relates to a program product, an image generation system, and an image generation method.

A game called a gun game, in which the player enjoys the game by shooting a target object on a screen using a gun-type controller (shooting device in a broad sense; pointing device in a broader sense), has been popular. In the gun game, when the player (operator) pulls the trigger of the gun-type controller, a shot impact position (indication position in a broad sense) is optically detected by utilizing a photosensor provided in the gun-type controller. The target object is determined to be hit when the target object exists at the detected shot impact position, and the target object is determined to be missed when the target object does not exist at the detected shot impact position. The player can virtually experience shooting in the real world by playing the gun game.

In the gun game, processing of flashing the screen is performed when detecting the shot impact position. The luminance of scan light can be increased by flashing the screen when detecting the scan light using the photosensor. This increases the amount of light incident on the photosensor, whereby the detection accuracy of the shot impact position can be increased and the shot impact position can be stably detected. A related-art flash image generation technology is disclosed in Japanese Patent Application Laid-Open No. 2001-5613.

However, various types of display sections (monitors) are connected with a consumer game device or the like. Therefore, it is necessary to increase the luminance of the flash image in order to accurately detect the shot impact position irrespective of the type of display section. However, if the luminance of the flash image is increased to a large extent, the screen flashes in white, whereby the player is given an unusual impression. In particular, when the gun-type controller can perform high-speed continuous firing similar to that of a machine gun, the screen frequently flashes on and off due to high-speed continuous firing, whereby the image becomes further affected.

### SUMMARY

A first aspect of the invention relates to a program product for generating an image, the program product causing a computer to function as:

a flash image generation section which generates a flash image which increases luminance of scan light for detecting an indication position of a pointing device including a photosensor which detects scan light from a display section;

a luminance adjustment processing section which displays a luminance adjustment screen for adjusting luminance of the flash image in the display section, and sets luminance adjustment information of the flash image by luminance adjustment using the luminance adjustment screen; and

an image generation section which generates an image displayed in the display section,

wherein the flash image generation section generates the flash image at a luminance set by the luminance adjustment information.

A second aspect of the invention relates to an image generation system for generating an image, the system comprising:

a flash image generation section which generates a flash image which increases luminance of scan light for detecting an indication position of a pointing device including a photosensor which detects scan light from a display section;

a luminance adjustment processing section which displays a luminance adjustment screen for adjusting luminance of the flash image in the display section, and sets luminance adjustment information of the flash image by luminance adjustment using the luminance adjustment screen; and

an image generation section which generates an image displayed in the display section,

wherein the flash image generation section generates the flash image at a luminance set by the luminance adjustment information.

A third aspect of the invention relates to an image generation method for generating an image, the method comprising:

generating a flash image which increases luminance of scan light for detecting an indication position of a pointing device including a photosensor which detects scan light from a display section;

displaying a luminance adjustment screen for adjusting luminance of the flash image in the display section;

setting luminance adjustment information of the flash image by luminance adjustment using the luminance adjustment screen;

generating an image displayed in the display section; and

generating the flash image at a luminance set by the luminance adjustment information.

### BRIEF DESCRIPTION OF THE SEVERAL VIEWS OF THE DRAWING

FIG. 1 is an example when applying an embodiment of the invention to a consumer game system.

FIG. 2 is an example of a block diagram of an image generation system according to an embodiment of the invention.

FIG. 3 is a configuration example of a position detection section.

FIGS. 4A, 4B, and 4C are illustrative of an indication position detection method.

FIGS. 5A and 5B are illustrative of a luminance adjustment screen.

FIGS. 6A and 6B are illustrative of a luminance adjustment screen.

FIGS. 7A and 7B are illustrative of a luminance adjustment screen.

FIG. 8 is illustrative of a high-luminance flash method.

FIG. 9 is illustrative of a low-luminance flash method.

FIG. 10 is illustrative of a method of using a low-luminance flash and a high-luminance flash in combination.

FIG. 11 is illustrative of a method of using a low-luminance flash and a high-luminance flash in combination.

FIG. 12 is illustrative of a method of using a low-luminance flash and a high-luminance flash in combination.

FIGS. 13A to 13D are illustrative of a luminance conversion method using an a-value.

FIGS. 14A and 14B are illustrative of a luminance conversion method using an a-value.

FIG. 15 is a flowchart of detailed processing according to an embodiment of the invention.

FIG. 16 is a flowchart of detailed processing according to an embodiment of the invention.

FIG. 17 is a flowchart of detailed processing according to an embodiment of the invention.

### DETAILED DESCRIPTION OF THE EMBODIMENT

The invention has been achieved in view of the above-described technical problem, and may provide an image generation system, a program product, and an image generation method which enable generation of a flash image at an appropriate luminance.

One embodiment of the invention provides an image generation system for generating an image, the system comprising:

a flash image generation section which generates a flash image which increases luminance of scan light for detecting an indication position of a pointing device including a photosensor which detects scan light from a display section;

a luminance adjustment processing section which displays a luminance adjustment screen for adjusting luminance of the flash image in the display section, and sets luminance adjustment information of the flash image by luminance adjustment using the luminance adjustment screen; and

an image generation section which generates an image displayed in the display section,

wherein the flash image generation section generates the flash image at a luminance set by the luminance adjustment information.

Another embodiment of the invention provides a program product which causes a computer to function as the above sections.

According to the embodiment, the luminance adjustment screen is displayed in the display section, and the luminance adjustment information of the flash image is set by the luminance adjustment using the luminance adjustment screen. The luminance of the flash image generated for detecting the indication position of the pointing device by detecting the scan light is set based on the luminance adjustment information. This enables a flash image at an appropriate luminance to be generated based on the luminance adjustment information set using the luminance adjustment screen, whereby a suitable operation interface environment can be provided.

With the image generation system, program product, and image generation method, the luminance adjustment processing section may display a luminance adjustment window in the display section, change a luminance value of the luminance adjustment window, determine whether or not the indication position of the pointing device is detected in the luminance adjustment window, and set the luminance adjustment information based, on the luminance value of the luminance adjustment window at a time of detecting the indication position.

This ensures that the indication position of the pointing device can be reliably detected when generating the flash image.

With the image generation system, program product, and image generation method, the luminance adjustment processing section may gradually increase the luminance value of the luminance adjustment window, and set the luminance adjustment information, based on the luminance value of the luminance adjustment window at a time of detecting the indication position of the pointing device.

With the image generation system, program product, and image generation method, the luminance adjustment processing section may display the luminance adjustment window in the display region except an inner circumferential region which is defined as a region along four sides of a screen of the display section and having a given width.

This effectively prevents occurrence of a situation in which the indication position cannot be appropriately detected during the luminance adjustment.

With the image generation system, program product, and image generation method, the luminance adjustment processing section may display an alert when the luminance value of the luminance adjustment window, at a time of detecting an indication position of the pointing device, is at least one of greater than a given upper limit and smaller than a given lower limit.

This makes it possible to prompt the player to change the setting of the luminance of the display section, whereby the operation interface environment can be improved.

With the image generation system, program product, and image generation method, the luminance adjustment processing section may set a default value as the luminance adjustment information when the luminance adjustment information has not been set by the luminance adjustment using the luminance adjustment screen.

With the image generation system, program product, and image generation method, the luminance adjustment information may be an a-value, and

the flash image generation section may generate the flash image by drawing a polygon with a size of a screen or a size dividing the screen in a drawing buffer in which an original image is drawn while performing a-blending.

With the image generation system, program product, and image generation method, the luminance adjustment information may be an a-value, and

the flash image generation section may generate the flash image by drawing a polygon with a size of a screen or a size dividing the screen in a drawing buffer in which an original image is drawn while performing subtractive a-blending in which a negative luminance value is clamped to zero, and draw a polygon with the size of the screen or the size dividing the screen in the drawing buffer while performing additive a-blending.

This enables the flash image to be generated at a low processing load.

With the image generation system, program product, and image generation method, the flash image generation section may generate a low-luminance flash image in a low-luminance flash period, and generate a high-luminance flash image in a high-luminance flash period.

An unusual image can be prevented from being generated by detecting the indication position while generating the low-luminance flash image. The indication position of the pointing device can be reliably detected by detecting the indication position while generating the high-luminance flash image, even when the indication position cannot be detected by utilizing the low-luminance flash image.

With the image generation system, program product, and image generation method, the flash image generation section may generate the low-luminance flash image and the high-luminance flash image so that a luminance difference between the low-luminance flash image and the high-luminance flash image does not change when the luminance adjustment information is changed by adjustment using the luminance adjustment screen.

An unusual impression on the player can be further reduced by making the luminance difference constant irrespective of the value of the luminance adjustment information.

Preferred embodiments of the invention are described below with reference to the drawings. The following description is given taking the case of applying the invention to a gun game (shooting game) using a gun-type controller as an example. However, the invention is not limited thereto. The invention may be applied to various games. Note that the embodiments described hereunder do not in any way limit the scope of the invention defined by the claims laid out herein. Note also that not all of the elements of these embodiments should be taken as essential requirements to the means of the present invention.

1. Configuration

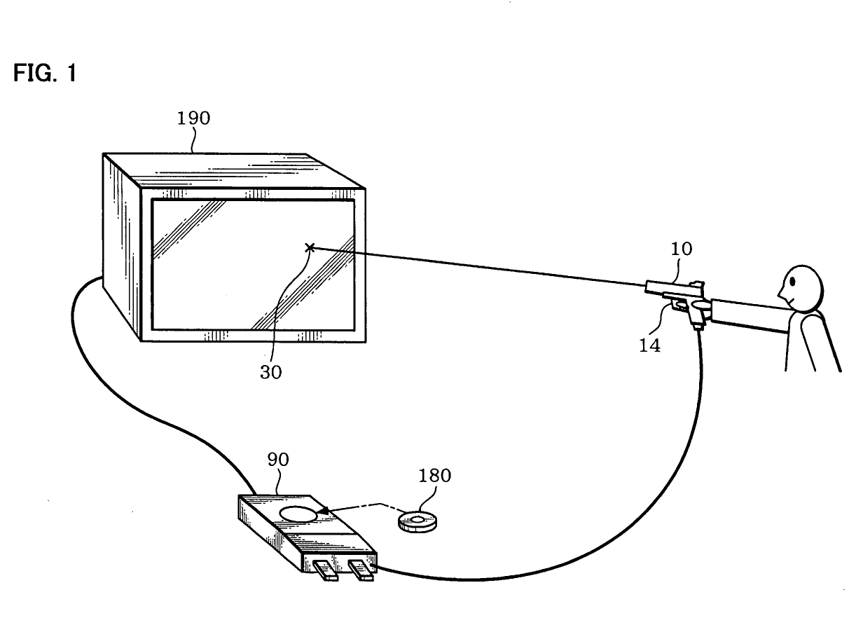

FIG. 1 shows an example when applying an embodiment of the invention to a consumer game system. A player holds a gun-type controller 10 (shooting device in a broad sense; pointing device in a broader sense; hereinafter the same) formed to imitate a gun, and pulls a trigger 14 aiming at a target object displayed on a screen of a display section 190. The scan light from an indication position 30 of the gun-type controller 10 is optically detected by a photosensor or the like provided in the gun-type controller 10. It is determined that the player has hit the target object when the indication position 30 of the gun-type controller 10 coincides with the position of the target object displayed on the screen, and it is determined that the player has missed the target object when the indication position 30 does not coincide with the position of the target object.

The gun-type controller 10 according to the embodiment is configured to automatically and continuously fire virtual shots (bullets) at a high speed when the player pulls the trigger 14 (in a high-speed continuous firing mode). Therefore, the player can experience virtual reality as if the player has fired an actual machine gun.

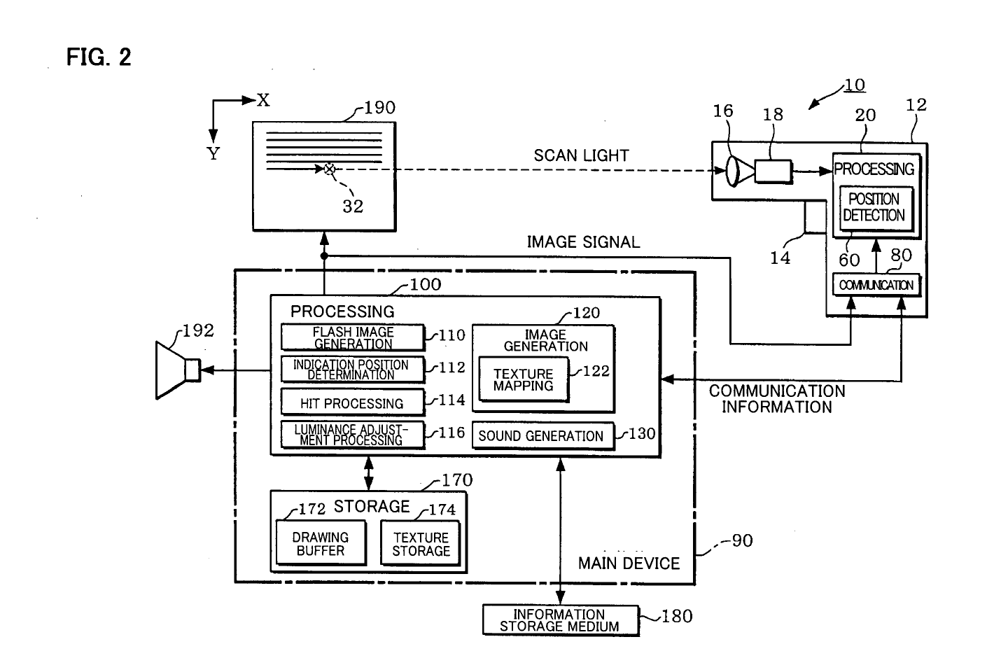

FIG. 2 shows a block diagram of an image generation system (game system or position detection system) according to the embodiment. The image generation system according to the embodiment may be configured to exclude some of the constituent elements (sections) shown in FIG. 2.

The gun-type controller 10 includes an indicator 12 (casing) formed to imitate the shape of a gun, the trigger 14 provided to a grip section of the indicator 12, and a lens 16 (optical system) and a photosensor 18 provided near a muzzle of the indicator 12. The gun-type controller 10 also includes a processing section 20 which controls the entire gun-type controller and calculates the indication position or the like, and a communication section 80 which functions as an interface with a main device 90. The processing section 20 includes a position detection section 60 which calculates the indication position (shot impact position in a narrow sense) of the gun-type controller 10. The gun-type controller 10 may be configured to exclude some of these sections. The functions of the processing section 20 and the communication section 80 may be realized by hardware such as an ASIC, or may be realized by a combination of various processors and software, for example.

The main device 100 (consumer game system) includes a processing section 100 and a storage section 170. The processing section 100 (processor) performs various types of processing such as game processing, image generation processing, or sound generation processing based on a program and data stored in an information storage medium 180 and information on communication with the gun-type controller 10 (e.g. indication position information, correction information, or detected error information). In this case, the processing section 100 performs various types of processing using the storage section 170 as a work area.

As the processing performed by the processing section 100, processing of setting various modes, processing of proceeding with a game, processing of setting a selection screen, processing of calculating the position and the rotational angle (rotational angle around X, Y, or Z axis) of an object (one or more primitives), processing of causing an object to take action (motion processing), processing of controlling a virtual camera (processing of calculating the position and the rotational angle of the virtual camera), processing of positioning an object such as a map or a building in an object space, hit check processing, processing of calculating game results (record), processing of allowing a plurality of players to play in a common game space, game-over processing, and the like can be given.

The storage section 170 functions as a work area for the processing section 100. The function of the storage section 170 may be realized by a RAM (VRAM) or the like. The information storage medium 180 (computer-readable medium; an example of a program product) stores a program, data, and the like. The function of the information storage medium 180 may be realized by an optical disk (CD or DVD), a hard disk, a memory card, a memory cassette, a magnetic disk, a memory (ROM), or the like. The processing section 100 performs various types of processing according to the embodiment based on a program (data) stored in the information storage medium 180. Specifically, a program for causing a computer to function as each section according to the embodiment (program for causing a computer to execute the processing of each section) is stored in the information storage medium 180.

A display section 190 outputs an image generated according to the embodiment. The function of the display section 190 may be realized by a TV, a CRT, or the like. A sound output section 192 outputs sound generated according to the embodiment. The function of the sound output section 192 may be realized by a speaker, a headphone, or the like.

The program (data or program product) for causing a computer to function as each section according to the embodiment may be distributed to the information storage medium 180 (storage section 170) from an information storage medium provided in a host device (server) through a network and a communication section 196. Use of the information storage medium of the host device (server) may be included within the scope of the invention.

The processing section 100 (processor) includes a flash image generation section 110, an indication position determination section 112, a hit processing section 114, a luminance adjustment processing section 116, an image generation section 120, and a sound generation section 130. The processing section 100 may be configured to exclude some of these sections.

The flash image generation section 110 performs processing of generating a flash image which increases the luminance of the scan light when detecting the indication position. For example, the flash image generation section 110 generates a low-luminance flash image in a low-luminance flash period, and generates a high-luminance flash image in a high-luminance flash period. In other words, the flash image generation section 110 generates the low-luminance flash image in an M-th frame, and generates the high-luminance flash image in an N-th frame differing from the M-th frame.

For example, the low-luminance flash period and the high-luminance flash period are alternately repeated so that the high-luminance flash period is set between one low-luminance flash period and the next low-luminance flash period. While the low-luminance flash image is generated in a plurality of frames (plurality of times) in the low-luminance flash period, the high-luminance flash image is generated only in one frame (may be a plurality of frames) in the high-luminance flash period, for example. The low-luminance flash period in which the low-luminance flash image is generated at given frame intervals (intervals of two frame or more) and the high-luminance flash period in which the high-luminance flash image is generated only in one frame (may be a plurality of frames) are alternately repeated. Or, the low-luminance flash period in which the low-luminance flash image is generated in all frames and the high-luminance flash period in which the high-luminance flash image is generated only in one frame (may be a plurality of frames) are alternately repeated.

The low-luminance flash image is an image (frame image) in which the luminances (luminance obtained by multiplying the luminance of each of R, G, and B by each coefficient and adding up the resulting values; luminances of all of R, G, and B; luminance of at least one of R, G, and B) of all pixels (all pixels excluding some exceptional pixels; all pixels as indication position detection targets) are set to be equal to or greater than a first luminance value (lowest luminance value which can be detected by the photosensor or the like; value greater than zero; first brightness). In this case, it is preferable that the low-luminance flash image be an image in which the luminances of all pixels are set to be equal to or greater than the first luminance value while maintaining the contrast of the original image (image drawn in a drawing buffer; frame image after perspective transformation). However, the low-luminance flash image may be an image in which the luminances of all pixels are set to be equal to or greater than the first luminance value without maintaining the contrast of the original image (e.g. image in which the entire screen is in a predetermined color such as white, gray, red, green, or blue; image in which the luminances of all of R, G, and B are set at the first luminance value).

The high-luminance flash image is an image (frame image) in which the luminances (luminance obtained by multiplying the luminance of each of R, G, and B by each coefficient and adding up the resulting values; luminances of all of R, G, and B; luminance of at least one of R, G, and B) of all pixels (all pixels excluding some exceptional pixels; all pixels as indication position detection targets) are set to be equal to or greater than a second luminance value (luminance value which can be reliably detected by the photosensor or the like; value greater than the first luminance value; second brightness higher than the first brightness). In this case, it is preferable that the high-luminance flash image be an image in which the luminances of all pixels are set to be equal to or greater than the second luminance value without maintaining the contrast of the original image (e.g. image in which the entire screen is in a predetermined color such as white, gray, red, green, or blue; image in which the luminances of all of R, G, and B are set at the second luminance value). However, the high-luminance flash image may be an image in which the luminances of all pixels are set to be equal to or greater than the second luminance value while maintaining the contrast of the original image.

The indication position determination section 112 performs processing of determining the indication position (virtual bullet impact position) of the gun-type controller 10 (pointing device). In more detail, the indication position determination section 112 determines the indication position of the gun-type controller 10 based on indication position information detected by the position detection section 60. Or, the indication position determination section 112 determines the indication position of the gun-type controller 10 based on an interpolated position obtained by interpolating a plurality of indication positions detected by the position detection section 60 or an extrapolated position (predicted position) obtained by extrapolating a plurality of previous indication positions.

The hit processing section 114 (hit check section) performs hit processing between the virtual bullet (shot) from the gun-type controller 10 (weapon-type controller) and the target object. In more detail, the hit processing section 114 determines the path of the virtual bullet based on the indication position (virtual bullet impact position) of the gun-type controller 10 determined (detected) by the indication position determination section 112 (position detection section 60), and determines whether or not the path has intersected the target object in the object space. The hit processing section 114 determines that the virtual bullet has hit the target object when the path has intersected the target object, and performs processing of decreasing the durability value (physical strength value) of the target object, processing of generating an explosion effect, processing of changing the position, direction, motion, color, or shape of the target object, or the like. The hit processing section 114 determines that the virtual bullet has not hit the target object when the path has not intersected the target object, and performs processing of deleting and extinguishing the virtual bullet. A simple object (bounding volume or bounding box) which simply represents the shape of the target object may be provided (disposed at the position of the target object), and a hit check between the simple object and the virtual bullet (path of the virtual bullet) may be performed.

The luminance adjustment processing section 116 performs various types of processing for adjusting the luminance of the flash image (low-luminance flash image or high-luminance flash image). For example, the luminance adjustment processing section 116 performs control of displaying a luminance adjustment screen for adjusting the luminance of the flash image in the display section. The luminance adjustment screen is displayed during initial adjustment before starting the game, or displayed when the player selects a luminance adjustment mode in an option screen in a main menu, for example. The player can appropriately adjust the luminance of the flash image by performing a predetermined operation directed in the luminance adjustment mode in which the luminance adjustment screen is displayed.

The luminance adjustment processing section 116 performs processing of setting luminance adjustment information of the flash image by luminance adjustment using the luminance adjustment screen. As the luminance adjustment information, an a-value for a-blending processing (translucent processing), the luminance value (RGB), or the like may be used. The a-value is information which can be stored while being associated with each pixel (texel or dot), and is additional information other than the color information. The a-value may be used as translucency (equivalent to transparency or opacity) information, mask information, bump information, or the like.

The flash image generation section 110 generates a flash image at a luminance (brightness) set by the luminance adjustment information. In this case, the flash image as the adjustment target of the luminance adjustment information may be either the low-luminance flash image or the high-luminance flash image. The flash image as the adjustment target may be both the low-luminance flash image and the high-luminance flash image. When the luminance adjustment information is the a-value, the flash image may be generated by a-blending (e.g. normal a-blending or additive a-blending) a polygon with a screen size (or a size into which the screen is divided (screen division size)) into the original image (image drawn in the drawing buffer) based on the a-value and drawing the resulting image. Specifically, the a-value as the luminance adjustment information is set for the polygon, and the polygon is drawn in the drawing buffer 172 in which the original image is drawn while performing a-blending based on the a-value. It is preferable to generate the low-luminance flash image and the high-luminance flash image so that the luminance difference between the low-luminance flash image and the high-luminance flash image is not changed even if the luminance adjustment information is changed by adjustment using the luminance adjustment screen.

The luminance adjustment processing section 116 performs control of displaying a luminance adjustment window. In this case, the luminance adjustment window is displayed in a region excluding regions having a given width and formed internally along the four sides of the screen of the display section 190 (first to fourth regions formed internally along first to fourth sides), for example. The luminance adjustment processing section 116 changes the luminance value (brightness) of the luminance adjustment window. For example, the luminance adjustment processing section 116 gradually increases the luminance value of the luminance adjustment window (gradually brightens the luminance adjustment window so that the luminance adjustment window becomes white from black). Or, the luminance adjustment processing section 116 may gradually decrease the luminance value (gradually darken the luminance adjustment window so that the luminance adjustment window becomes black from white). The processing of changing the luminance value of the luminance adjustment window may be started on condition that the trigger 14 of the gun-type controller 10 has been pulled (on condition that the player has performed a given operation), for example.

The luminance adjustment processing section 116 determines whether or not the indication position of the gun-type controller 10 (pointing device) has been detected in the luminance adjustment window. The luminance adjustment processing section 116 sets the luminance adjustment information based on the luminance value (brightness information) of the luminance adjustment window when the indication position is detected. In the method of increasing the luminance value of the luminance adjustment window, the luminance adjustment information is set based on the luminance value of the luminance adjustment window acquired in the frame in which the indication position of the gun-type controller 10 is detected or a frame within a given number of frames (within N frames; N is a natural number) from the frame in which the indication position of the gun-type controller 10 is detected, for example. In the method of decreasing the luminance value of the luminance adjustment window, the luminance adjustment information is set based on the luminance value of the luminance adjustment window acquired in the frame in which the indication position of the gun-type controller 10 becomes undetectable or a frame within a given number of frames (within N frames) from the frame in which the indication position of the gun-type controller 10 becomes undetectable. The processing of calculating the luminance adjustment information (a-value) from the luminance value may be realized by calculation processing based on a given equation, or may be realized using a table in which the luminance value is associated with the luminance adjustment information.

The luminance adjustment processing section 116 performs control of displaying an alert when the luminance value of the luminance adjustment window when the indication position of the gun-type controller 10 (pointing device) is detected is greater than or smaller than a given upper limit. It is also possible to issue an alert using sound instead of the screen display. The luminance adjustment processing section 116 sets a default value as the luminance adjustment information when the luminance adjustment information has not been set (when the luminance adjustment information could not be obtained). Specifically, the luminance adjustment processing section 116 sets the default a-value or the like stored in the storage section 170 in advance as the luminance adjustment information.

The image generation section 120 performs image processing based on the results for various types of processing performed by the processing section 100, generates a game image, and outputs the game image to the display section 190. When generating a three-dimensional game image, geometry processing such as coordinate transformation, clipping processing, perspective transformation, or light source calculation is performed, and drawing data (e.g. positional coordinates assigned to vertices (constituent points) of the primitive surface, texture coordinates, color (luminance) data, normal vector, or a-value) is created based on the processing results. An image of the object (one or more primitive surfaces) after the geometry processing is drawn in the drawing buffer 172 (buffer which can store image information in pixel units, such as a frame buffer or a work buffer) based on the drawing data (primitive surface data). This allows generation of an image viewed from the virtual camera (given viewpoint) in the object space. An image generated according to the embodiment and displayed in the display section 190 may be either a three-dimensional image or a two-dimensional image.

A texture mapping section 122 included in the image generation section 120 performs processing of mapping a texture (texel value) stored in a texture storage section 174 onto the object. In more detail, the texture mapping section 122 reads a texture (surface properties such as color and a-value) from the texture storage section 174 using the texture coordinates set (assigned) to the vertices of the object (primitive surface) or the like. The texture mapping section 122 maps the texture which is a two-dimensional image or pattern onto the object. In this case, the texture mapping section 122 performs processing of associating the pixel with the texel, bilinear interpolation (texel interpolation), or the like.

The sound generation section 130 performs sound processing based on the results for various types of processing performed by the processing section 100. The sound generation section 130 generates game sound such as background music, effect sound, or voice, and outputs the generated game sound to the sound output section 192 (speaker).

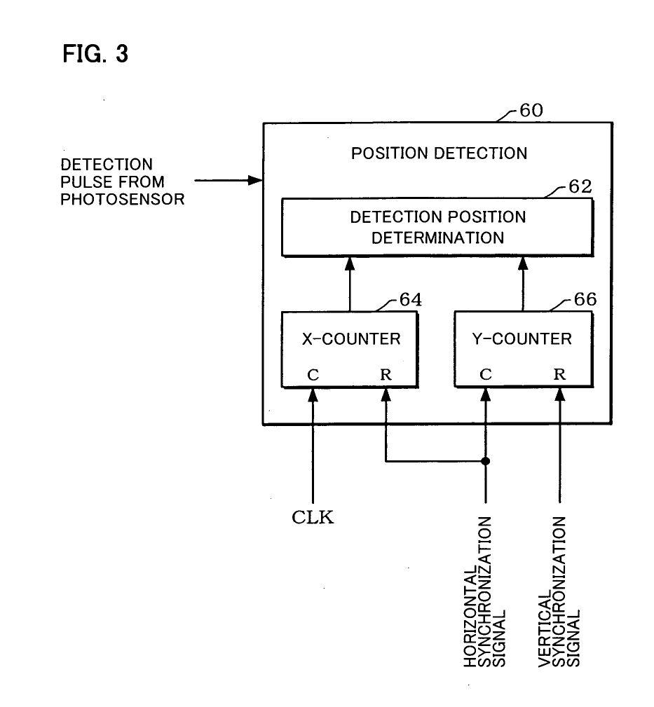

FIG. 3 shows a configuration example of the position detection section 60. The position detection section 60 performs processing of detecting the indication position (virtual bullet impact position) of the gun-type controller 10 based on a detection pulse transferred from the photosensor 18.

As shown in FIG. 3, the position detection section 60 includes a detection position determination section 62, an X-counter section 64, and a Y-counter section 66. The detection pulse from the photosensor 18 is input to the position detection section 60. The position detection section 60 detects the indication position of the gun-type controller 10 based on the detection pulse, a clock signal CLK, a horizontal synchronization signal, and a vertical synchronization signal (horizontal synchronization signal and vertical synchronization signal included in image signals from the main device).

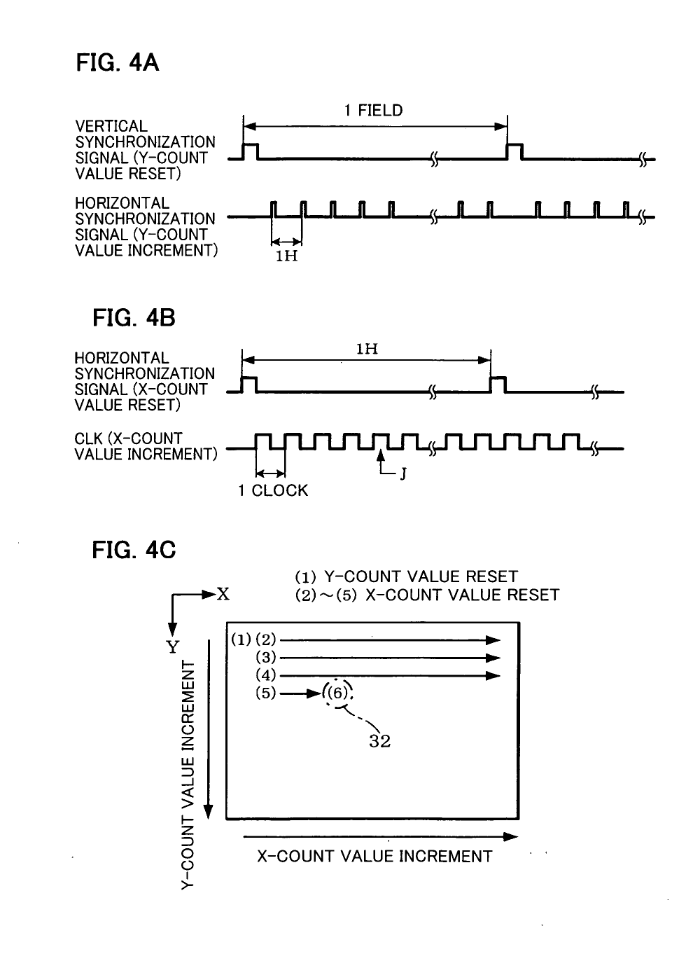

In more detail, the vertical synchronization signal and the horizontal synchronization signal are respectively input to a reset terminal R and a clock terminal C of the Y-counter section 66. The horizontal synchronization signal and the clock signal CLK are respectively input to a reset terminal R and a clock terminal C of the X-counter section 64. The vertical synchronization signal and the horizontal synchronization signal have the relationship as shown in FIG. 4A, and the horizontal synchronization signal and the clock signal CLK have the relationship as shown in FIG. 4B.

According to the configuration shown in FIG. 3, a Y-count value of the Y-counter section 66 is reset at a point (1) shown in FIG. 4C, that is, at the first point in one field period. The Y-count value is sequentially incremented in units of 1 H periods (horizontal scan periods).

An X-count value of the X-counter section 64 is reset at points (2) to (5) shown in FIG. 4C, that is, at the first point in the 1 H period. The X-count value is sequentially incremented each time the clock signal CLK rises, for example.

For example, consider the case where the pulse from the photosensor 18 is detected when the scan light (raster scan) has reached the point (6) (detection area 32) shown in FIG. 4C. The detection position determination section 62 calculates an X-coordinate and a Y-coordinate corresponding to the X-count value and the Y-count value based on the X-count value and the Y-count value of the X-counter section 64 and the Y-counter section 66 at that point. This enables the positional coordinates of the point (6), that is, the coordinates of the indication position of the gun-type controller 10 to be detected. The Y-count value is “4” in FIG. 4C, and the Y-coordinate of the point (6) is uniquely determined based on the Y-count value “4”. Since the X-count value has been reset at the point (5), the X-count value is the number of times the clock signal CLK rises between the points (5) and (6). For example, if the pulse from the photosensor 18 is detected at a position “J” shown in FIG. 4B, the X-count value is “5”. The X-coordinate of the point (6) is uniquely determined based on the X-count value “5”.

In FIG. 2, the position detection section 60 is provided in the gun-type controller 10. However, the position detection section 60 may be provided in the processing section 100.

The image generation system according to the embodiment may be a system exclusive to a single-player mode in which only one player can play the game, or may be a system provided with a multi-player mode in which a plurality of players can play the game in addition to the single-player mode.

In the case where a plurality of players play the game, game images and game sound provided to the players may be generated using one terminal, or may be generated using a plurality of terminals (game devices or portable telephones) connected through a network (transmission line or communication line) or the like.

2. Method According to Embodiment

2.1 Luminance Adjustment Screen

In a related-art image generation system using a gun-type controller, the player cannot adjust the luminance of the flash image. In the case of a high-luminance flash described later, a high-luminance flash image which flashes the entire screen in white is generated to detect the indication position. In the case of a low-luminance flash described later, the luminance of the low-luminance flash image is set at an optimum luminance before shipment, and the player cannot adjust the luminance of the low-luminance flash image.

However, various display sections (monitors) may be connected with a main device of a consumer game device or the like. Moreover, the player may adjust the luminance of the display section to a luminance the player prefers. Therefore, a situation may occur in which the indication position cannot be appropriately detected if the flash image is generated at a default luminance set before shipment. If the luminance of the flash image is increased in order to prevent occurrence of such a situation, the screen flashes in white, whereby the player is given an unusual impression. In particular, when the gun-type controller performs high-speed continuous firing similar to that of a machine gun, the screen frequently flashes on and off due to high-speed continuous firing, whereby the image becomes further affected.

In the embodiment, the luminance adjustment screen for adjusting the luminance of the flash image (at least one of low-luminance flash image and high-luminance flash image) is displayed in the display section so that the player can appropriately adjust the luminance of the flash image using the luminance adjustment screen.

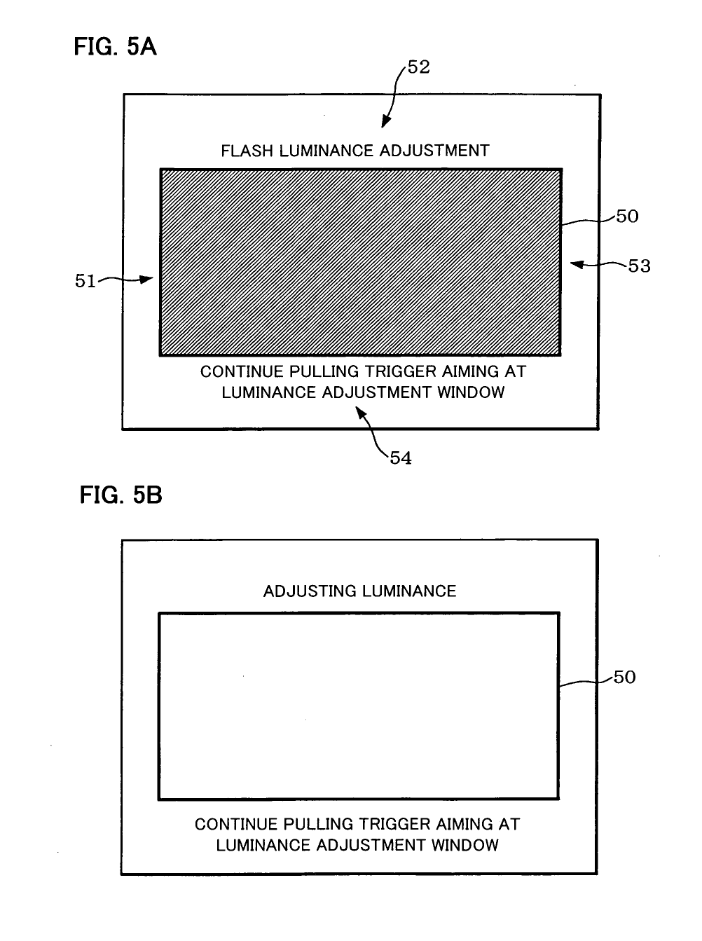

FIG. 5A shows an example of the luminance adjustment screen. As shown in FIG. 5A, a luminance adjustment window 50 is displayed in the luminance adjustment screen. The quadrilateral luminance adjustment window 50 is displayed in a region (center region) excluding the inner circumferential regions (regions 51, 52, 53, and 54) formed internally along the four sides of the screen of the display section. A situation may occur in which the indication position cannot be appropriately detected in the inner circumferential regions of the screen. However, occurrence of such a situation can be prevented by displaying the luminance adjustment window 50 in the center region of the screen excluding the inner circumferential regions as shown in FIG. 5A.

As indicated by A1 in FIG. 5A, the luminance adjustment screen directs the player to pull the trigger of the gun-type controller aiming at the luminance adjustment window 50. When the player pulls the trigger while holding the gun-type controller toward the luminance adjustment window 50 and continues pulling the trigger, the luminance value of the luminance adjustment window 50 is gradually increased. In more detail, the RGB components of the luminance of the luminance adjustment window 50 are changed from (RMIN, GMIN, BMIN) to (RMAX, GMAX, BMAX). Suppose that the relationship indicated by “RMIN<RMAX, GMIN<GMAX, BMIN<BMAX” is satisfied. In more detail, the brightness of the luminance adjustment window 50 is changed from black ((R, G, B)=(0, 0, 0)) as shown in FIG. 5A to white ((R, G, B)=(255, 255, 255)) as shown in FIG. 5B.

Since the gun-type controller faces the luminance adjustment window 50 and indicates one position of the luminance adjustment window 50, the position detection section of the gun-type controller performs the detection operation of the indication position. When the indication position of the gun-type controller has been detected (when the indication position information from the gun-type controller has been received), the luminance adjustment information (e.g. a-value) on the flash image is set based on the luminance value (luminance information) of the luminance adjustment window 50 when the indication position is detected. For example, when the indication position is detected in the frame K, the luminance adjustment information is set based on the luminance value of the luminance adjustment window 50 in the frame K. Or, when the indication position is detected in the frame K, the luminance adjustment information may be set based on the luminance value of the luminance adjustment window 50 in a frame subsequent to the frame K (e.g. frame K+1 or K+2).

The luminance value of the luminance adjustment window 50 may be gradually decreased when the player pulls the trigger while holding the gun-type controller toward the luminance adjustment window 50 and continues pulling the trigger. In more detail, the RGB components of the luminance of the luminance adjustment window 50 are changed from (RMAX, GMAX, BMAX) to (RMIN, GMIN, BMIN). In more detail, the brightness of the luminance adjustment window 50 is changed from white ((R, G, B)=(255, 255, 255)) as shown in FIG. 5B to black ((R, G, B)=(0, 0, 0)) as shown in FIG. 5A. In this case, when the indication position of the gun-type controller has become undetectable, the luminance adjustment information is set based on the luminance value of the luminance adjustment window 50 when the indication position is detected. For example, when the indication position has become undetectable in the frame K, the luminance adjustment information is set based on the luminance value of the luminance adjustment window 50 in the frame K−1 in which the indication position is detected. Or, the luminance adjustment information may be set based on the luminance value of the luminance adjustment window 50 in a frame preceding the frame K−1 (e.g. frame K−2 or K−3).

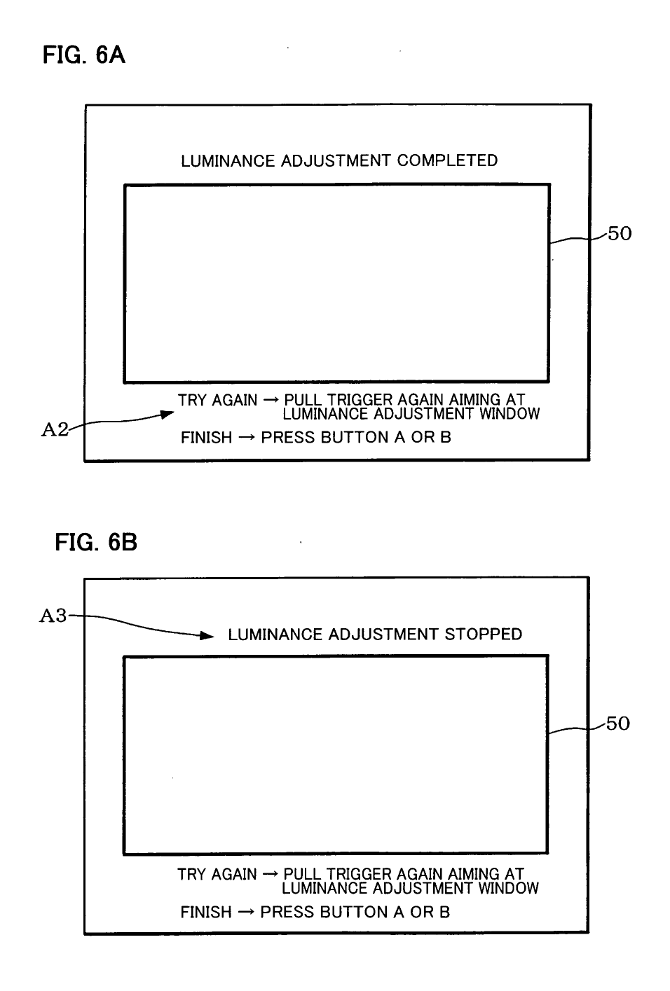

Upon succeeding in the luminance adjustment, a screen as shown in FIG. 6A is displayed. As indicated by A2 shown in FIG. 6A, when the player wants to again perform the luminance adjustment, the player pulls the trigger while holding the gun-type controller toward the luminance adjustment window 50. When finishing the luminance adjustment, the player presses a button A or a button B (operational button) of the gun-type controller.

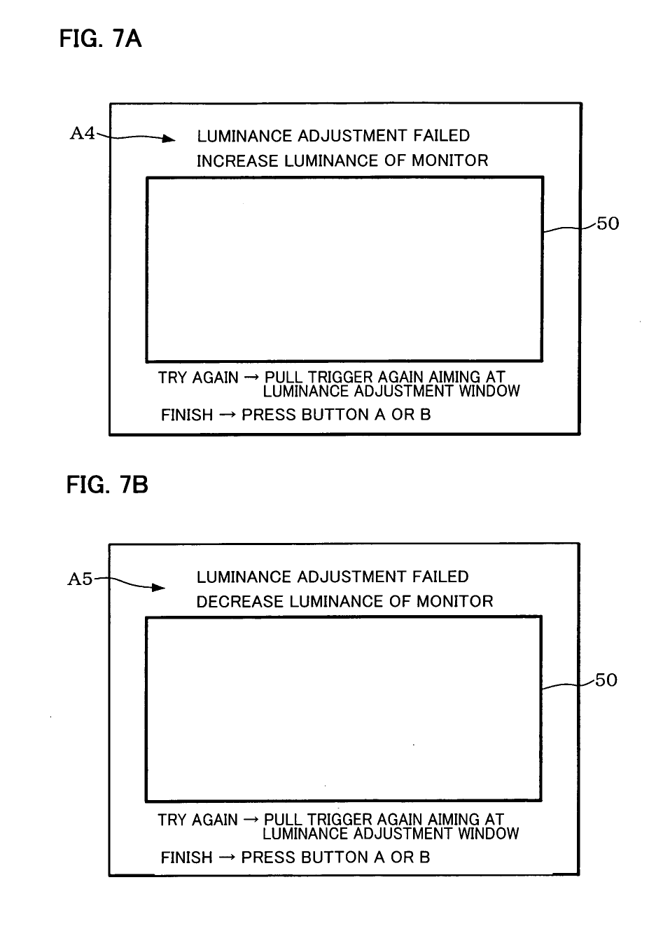

When the player suspends the luminance adjustment, an alert screen as shown in FIG. 6B is displayed. For example, when the player stops the trigger operation of the gun-type controller during the luminance adjustment, an alert as indicated by A3 in FIG. 6B is displayed. When the player has failed in the luminance adjustment, an alert screen as shown in FIG. 7A or 7B is displayed. For example, when the luminance value of the luminance adjustment window 50 acquired by the luminance adjustment is smaller than the lower limit, an alert as indicated by A4 in FIG. 7A is displayed. The player is directed to increase the luminance of the display section (monitor). When the luminance value of the luminance adjustment window 50 acquired by the luminance adjustment is greater than the upper limit, an alert as indicated by A5 in FIG. 7B is displayed. The player is directed to decrease the luminance of the display section. The player can set the luminance of the display section at an optimum luminance by performing such an alert display. When the luminance adjustment information has not been set (when the luminance adjustment information could not be obtained), the default value is set as the luminance adjustment information.

In the embodiment, the luminance of the flash image generated during the game is set based on the luminance adjustment information obtained using the luminance adjustment screen as shown in FIGS. 5A and 5B. Therefore, even if the type of display section or the game environment (e.g. indoor brightness) varies, a flash image at an optimum luminance can be generated. In FIGS. 5A and 5B, the luminance adjustment information is set based on the luminance value when the indication position of the gun-type controller is detected, and the luminance of the flash image is set based on the resulting luminance adjustment information. This ensures that the indication position of the gun-type controller can be reliably detected by generating the flash image, whereby the operation interface environment of the player can be improved.

The luminance adjustment method according to the embodiment is not limited to the method described with reference to FIGS. 5A and 5B. Various modifications and variations may be made. For example, a plurality of target objects having different luminance values are arranged and displayed in the luminance adjustment screen in the order from the target object having the lowest luminance value (or, in the order from the target object having the highest luminance value). The player is directed to pull the trigger while holding the gun-type controller toward each target object, and whether or not the virtual bullet from the gun-type controller has hit each target object (whether or not the indication position of the gun-type controller has coincided with the target object) is checked. The luminance adjustment information is set based on the luminance value of the target object successfully hit with the virtual bullet. According to this method, target objects having various luminance values which appear during the game can be reliably hit with the virtual bullet by generating a flash image of which the luminance is set using the resulting luminance adjustment information during the game.

2.2 Flash Image

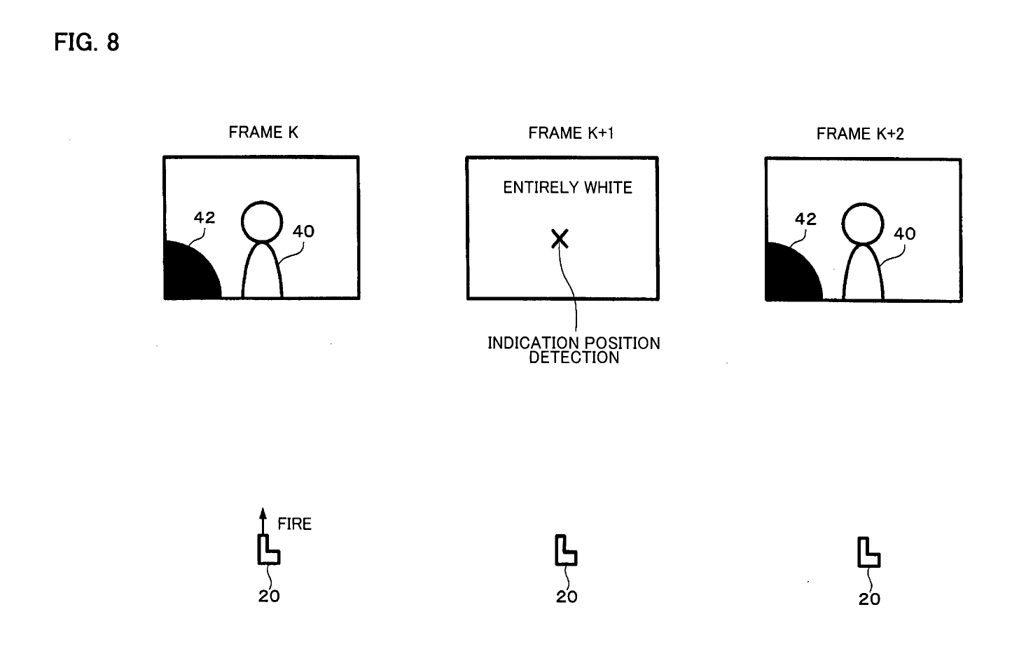

A flash image generation method is described below. FIG. 8 is illustrative of a high-luminance flash method. For example, when the player fires the gun-type controller by pulling the trigger in the frame K as shown in FIG. 8, the screen is flashed with a high-luminance flash image (e.g. the entire image is white) in the subsequent frame K+1. The scan light at the time of the high-luminance flash is detected by the photosensor to detect the indication position (virtual bullet impact position) of the gun-type controller.

In this case, since the screen becomes completely white when the screen is flashed by the high-luminance flash shown in FIG. 8, a problem occurs in which the player is given an unusual impression. However, such a problem can be reduced by setting the luminance adjustment information using the luminance adjustment screen according to the embodiment and adjusting the luminance of the high-luminance flash image based on the luminance adjustment information. For example, the RGB components (RH, GH, BH) of the luminance of the high-luminance flash image are adjusted between (RH−?R, GH−?G, BH−?B) and (RH+?R, GH+?G, BH+?B) based on the luminance adjustment information.

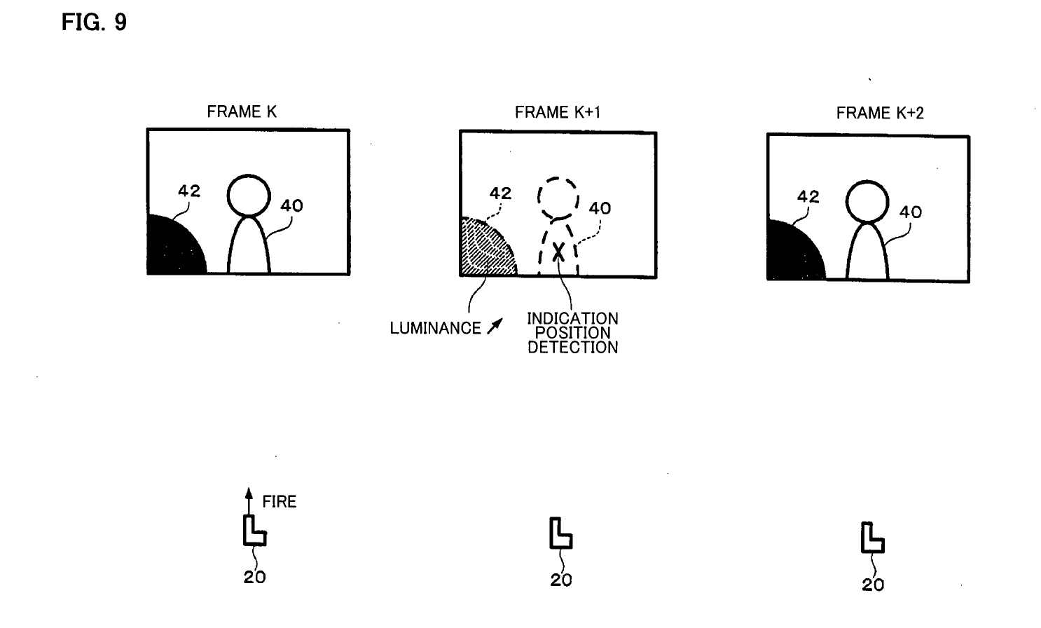

FIG. 9 is illustrative of a low-luminance flash method. For example, suppose that the player fires the gun-type controller by pulling the trigger in the frame K as shown in FIG. 9. In the subsequent frame K+1, a low-luminance flash is performed in which the luminances of all pixels are set to be equal to or greater than a given luminance value while maintaining the contrast of the original image to detect the indication position.

According to such a low-luminance flash method, since the contrast of display objects 40 and 42 remains to some extent when detecting the indication position, an unusual impression on the player can be reduced. Moreover, since the screen does not flicker to a large extent even if the virtual bullets are continuously discharged at a high speed, a situation in which the unusual impression on the player is increased can be prevented.

However, a problem occurs in which the indication position cannot be reliably detected according to the method of detecting the position using only the low-luminance flash. However, such a problem can be reduced by setting the luminance adjustment information using the luminance adjustment screen according to the embodiment and adjusting the luminance of the low-luminance flash image based on the resulting luminance adjustment information.

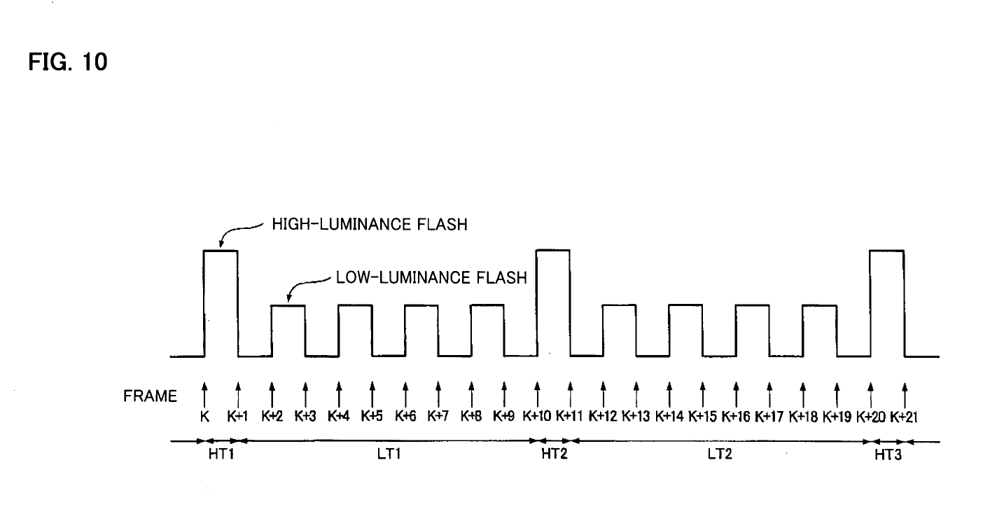

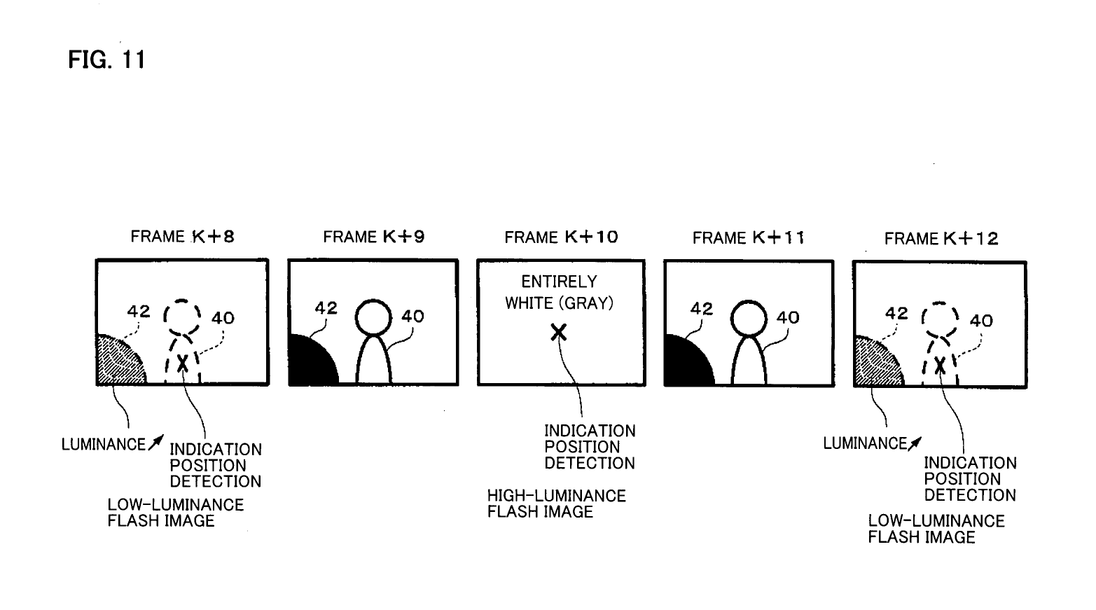

FIGS. 10 and 11 are illustrative of a method of using the low-luminance flash and the high-luminance flash in combination. As shown in FIG. 10, while performing the low-luminance flash at a frame interval NL, the high-luminance flash is performed instead of the low-luminance flash at a frame interval NH greater than the frame interval NL, for example.

In FIG. 10, the low-luminance flash is performed in the frames K+2, K+4, K+6, K+8, K+12, K+14, K+16, and K+18 (at frame intervals NL of “2”), for example. Specifically, the low-luminance flash image in which the luminances of all pixels are set to be equal to or greater than the first luminance value BR1 while maintaining the contrast of the original image (final frame image drawn in the drawing buffer) is generated in these frames.

The high-luminance flash is performed in the frames K, K+10, and K+20 (at frame intervals NH of “10”). Specifically, the high-luminance flash in which the luminances of all pixels are set to be equal to or greater than the second luminance value BR2 (BR2>BR1) without maintaining the contrast of the original image is generated in these frames. Specifically, the high-luminance flash image in which the entire screen is displayed in a predetermined color (e.g. white, gray, red, green, or blue) is generated. In other words, the low-luminance flash is performed in the low-luminance flash periods LT1 and LT2, and the high-luminance flash is performed in the high-luminance flash period HT2 set between the low-luminance flash period LT1 and the subsequent low-luminance flash period LT2.

This causes images as shown in FIG. 11 to be displayed on the screen of the display section 190. Specifically, the low-luminance flash image in which the luminance of the entire image is increased while maintaining the contrast of the original image is displayed in the frame K+8. In the subsequent frame K+9, the original image (original image in the frame) which is not subjected to the luminance conversion is displayed. In the subsequent frame K+10, the high-luminance flash image in which the entire screen is in a predetermined color (e.g. white or gray) is displayed. In the subsequent frame K+11, the original image (original image in the frame) which is not subjected to the luminance conversion is displayed. In the subsequent frame K+12, the low-luminance flash image in which the luminance of the entire image is increased while maintaining the contrast of the original image is displayed.

For example, since the high-luminance flash is performed in the frame K+10 in FIG. 11 without maintaining the contrast of the original image, the display objects 40 and 42 completely disappear (contrast=0). On the other hand, in the frames K+8 and K+12, the contrast of the display objects 40 and 42 remains to some extent (contrast>0). Moreover, the luminance of the display object 42, which is entirely black in the original image, is increased. Specifically, the luminances of all pixels of the screen are set to be equal to or greater than the first luminance value BR1 (e.g. lowest luminance value which can be detected by the photosensor or the like).

According to the method of using the low-luminance flash and the high-luminance flash in combination, since the contrast of the display objects 40 and 42 remain to some extent in the low-luminance flash period (frames K+9 and K+12), an unusual impression on the player can be reduced in comparison with the method shown in FIG. 8 in which the entire screen becomes white at the time of the flash. The luminance value of the display object 42 having a low luminance is increased by the low-luminance flash to a value equal to or greater than the optical detection threshold value of the photosensor, for example. Therefore, the shot impact position can be appropriately detected even if the shot hits the display object 42 having a low luminance. Moreover, even if the player continuously fires the virtual bullets at a high speed using the gun-type controller, the low-luminance flash image is displayed in most frames, and the high-luminance flash image is merely occasionally displayed. Therefore, an image which rarely causes the player to be given an unusual impression can be generated.

The frame interval NL and the first luminance value BR1 of the low-luminance flash and the frame interval NH and the second luminance value BR2 of the high-luminance flash are arbitrary, and may be appropriately adjusted. In FIG. 10, the frame interval NL of the low-luminance flash is set at “2”. However, the frame interval NL may be set at “3” or more.

In the low-luminance flash period, a low-luminance flash image in which the luminances of all pixels are set to be equal to or greater than the first luminance value BR1 may be generated without maintaining the contrast of the original image (image in which the entire screen is in a predetermined color). For example, a low-luminance flash in which the entire screen is gray may be performed in the low-luminance flash period, and a high-luminance flash in which the entire screen is white may be performed in the high-luminance flash period. Or, a high-luminance flash image in which the luminances of all pixels are set to be equal to or greater than the second luminance value BR2 without maintaining the contrast of the original image may be generated in the high-luminance flash period.

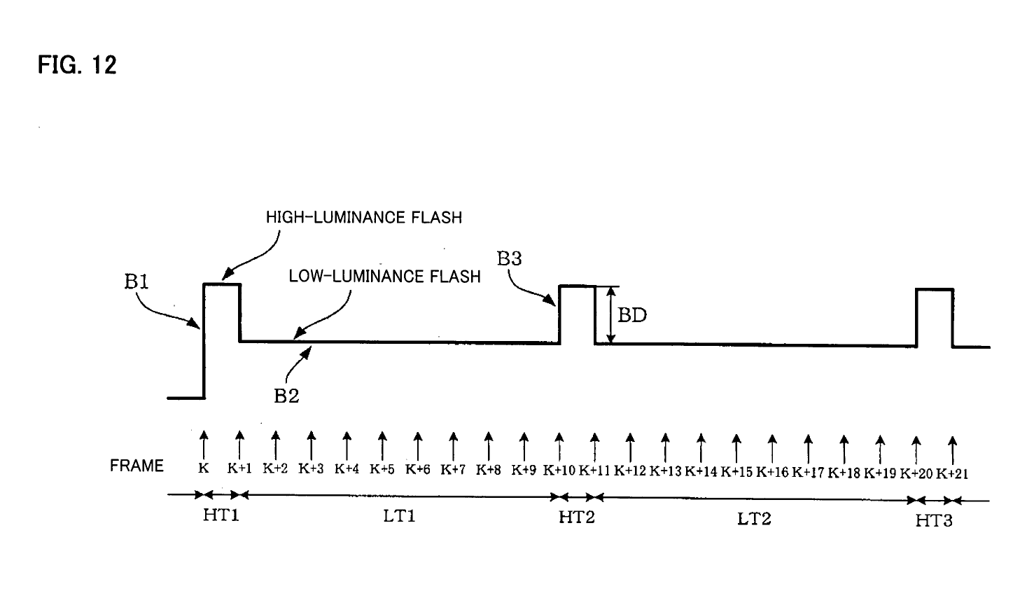

As shown in FIG. 12, the low-luminance flash image (flash image in which the contrast of the original image is maintained) may be generated in all frames in the low-luminance flash periods LT1, LT2, and LT3. In more detail, the low-luminance flash image starts to be displayed on condition that the gun-type controller has been operated to continuously discharge the virtual bullets (on condition that the operation for continuously detecting the indication position of the pointing device has been performed in a broad sense). The high-luminance flash image is occasionally displayed while continuously displaying the low-luminance flash image in all frames. Specifically, the high-luminance flash image is generated in the high-luminance flash period HT1 between the low-luminance flash periods LT1 and LT2 and the high-luminance flash period HT2 between the low-luminance flash periods LT2 and LT3.

According to the embodiment, the luminance adjustment information is set using the luminance adjustment screen, and the luminances of the flash images shown in FIGS. 10 to 12 are adjusted based on the luminance adjustment information. This enables the indication position of the gun-type controller to be more reliably detected even in the low-luminance flash period. The luminance of only the low-luminance flash image may be adjusted based on the luminance adjustment information, or the luminances of both the low-luminance flash image and the high-luminance flash image may be adjusted based on the luminance adjustment information.

In the embodiment, it is preferable to generate the low-luminance flash image and the high-luminance flash image so that the luminance difference between the low-luminance flash image and the high-luminance flash image is not changed even if the luminance adjustment information (a-value) is changed by the adjustment using the luminance adjustment screen. For example, the low-luminance flash image and the high-luminance flash image are generated so that the luminance difference BD shown in FIG. 12 is not changed when the luminance adjustment information is changed.

For example, when the trigger (initial trigger) of the gun-type controller has been pulled, the low-luminance flash image is displayed by drawing a polygon for which the a-value as the luminance adjustment information is set, and the high-luminance flash image is displayed by drawing a high-luminance flash polygon (white polygon), as indicated by B1 in FIG. 12. In the subsequent frames, the low-luminance flash image (drawing of the polygon for which the a-value is set) is continuously displayed as indicated by B2 in FIG. 12. In the high-luminance flash period, the high-luminance flash image is displayed by drawing the high-luminance flash polygon as indicated by B3 in FIG. 12. In this case, the luminance value of the high-luminance flash polygon drawn at B3 is made constant irrespective of the a-value. This prevents the luminance difference BD between the low-luminance flash image and the high-luminance flash image from being changed even if the luminance value of the low-luminance flash image indicated by B2 is increased due to an increase in the a-value, for example.

Specifically, the luminance of the screen may be occasionally changed by generating the high-luminance flash image, whereby the player may be given an unusual impression. If the luminance difference BD shown in FIG. 12 is increased when the luminance adjustment information (a-value) is changed, the luminance difference between the low-luminance flash image and the high-luminance flash image becomes conspicuous, whereby the player is given an unusual impression. On the other hand, an unusual impression on the player can be reduced by making the luminance difference BD constant irrespective of the value of the luminance adjustment information.

2.3 Generation of Flash Image While Maintaining Contrast

A flash image generation method while maintaining the contrast of the original image is described below.

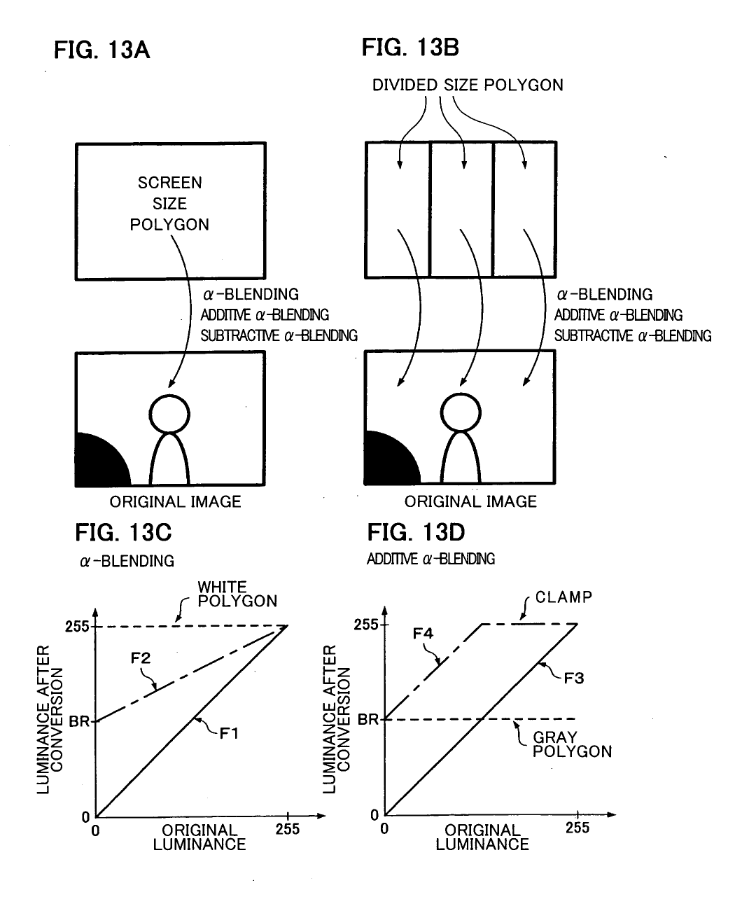

In FIGS. 13A and 13B, a polygon with a screen size (virtual polygon) or a polygon with a screen division size (virtual polygons in a number of divisions) is drawn in the drawing buffer (e.g. frame buffer) in which the original image (image after perspective transformation) is drawn while performing a-blending, additive a-blending, or subtractive a-blending. This enables a flash image (low-luminance flash image or high-luminance flash image) in which the luminances of all pixels are equal to or greater than a given luminance value (BR1 or BR2) to be generated while maintaining the contrast of the original image.

In FIG. 13C, a white polygon in which (R, G, B)=(255, 255, 255) (polygon in a predetermined color or a polygon onto which a flash texture is mapped in a broad sense) is drawn by a-blending in the drawing buffer in which the original image is drawn. This causes the luminance of the original image to be converted from F1 to F2. The luminance after conversion indicated by F2 is set so that the luminance of the pixel which is black (luminance value=0) in the original image is increased and is set to be equal to or greater than the luminance value BR (luminance value which can be detected by the photosensor; BR1 or BR2). This enables the indication (shot impact) position of the gun-type controller to be reliably detected even if the gun-type controller indicates a black pixel.

According to the method of converting the luminance of the original image by drawing a polygon using a-blending as shown in FIG. 13C, although the contrast is decreased, the linearity of the luminance after conversion with respect to the luminance of the original image (original luminance) is maintained (conversion characteristics of F2 become linear). Therefore, this method has an advantage in which the image quality does not deteriorate to a large extent.

In FIG. 13D, a gray polygon in which (R, G, B)=(BR, BR, BR) (polygon in a predetermined color or a polygon onto which a flash texture is mapped) is drawn by additive a-blending in the drawing buffer in which the original image is drawn. This causes the luminance of the original image to be converted from F3 to F4. In this additive a-blending, the luminance exceeding the maximum luminance value (255) is clamped to the maximum luminance value.

In the luminance after conversion indicated by F4, the luminance of the pixel which is black (luminance value=0) in the original image is increased and is set to be equal to or greater than the luminance value BR. This enables the indication (shot impact) position of the gun-type controller to be reliably detected even if the gun-type controller indicates a black pixel.

The method of converting the luminance of the original image by drawing a polygon by a-blending or additive a-blending as shown in FIG. 13C or 13D has an advantage in which the luminance of the original image can be converted by drawing only one polygon (or polygons in a number of divisions).

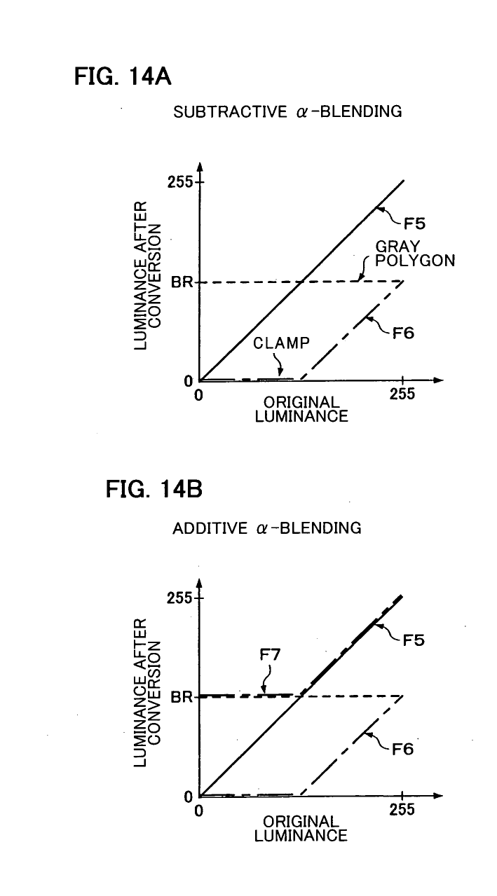

In FIG. 14A, a gray polygon in which (R, G, B)=(BR, BR, BR) (polygon in a predetermined color or a polygon onto which a flash texture is mapped) is drawn by subtractive a-blending in the drawing buffer in which the original image is drawn. This causes the luminance of the original image to be converted from F5 to F6. In this subtractive a-blending, the negative luminance value is clamped to zero.

After drawing the polygon by subtractive a-blending, a gray polygon in which (R, G, B)=(BR, BR, BR) (polygon in a predetermined color or a polygon onto which a flash texture is mapped) is drawn in the drawing buffer by additive a-blending, as shown in FIG. 14B. This causes the luminance to be converted from F6 to F7.

In the luminance after conversion indicated by F7, the luminance of the pixel which is black (luminance value=0) in the original image is increased and is set to be equal to or greater than the luminance value BR. This enables the indication (shot impact) position of the gun-type controller to be reliably detected even if the gun-type controller indicates a black pixel.

The method of converting the luminance of the original image by drawing a polygon by subtractive a-blending and drawing the polygon by additive a-blending as shown in FIGS. 14A or 14B has a disadvantage in which the information (contrast) on the luminance of the original image is lost in a low-luminance pixel. However, the loss of the luminance information on a dark pixel does not cause the image quality to deteriorate to a large extent. The method shown in FIGS. 14A and 14B has an advantage in which the luminance characteristics after conversion can be made almost equal to the luminance of the original image in a high-luminance pixel.

The a-blending shown in FIG. 13C may be expressed by the following equations, for example.
R_{Q}=(1−a)×R₁+a×R₂ (1)
G_{Q}=(1−a)×G₁+a×G₂ (2)
B_{Q}=(1−a)×B₁+a×B₂ (3)

The additive a-blending shown in FIGS. 13D and 14B may be expressed by the following equations, for example.
R_{Q}=R₁+a×R₂ (4)
G_{Q}=G₁+a×G₂ (5)
B_{Q}=B₁+a×B₂ (6)

The subtractive a-blending shown in FIG. 14A may be expressed by the following equations, for example.
R_{Q}=R₁−a×R₂ (7)
G_{Q}=G₁−a×G₂ (8)
B_{Q}=B₁−a×B₂ (9)

In the equations (1) to (9), R₁, G₁, and B₁ are RGB components of the luminance (color) of the image which has been drawn in the drawing buffer, and R₂, G₂, and B₂ are RGB components of the luminance of the polygon (virtual polygon) to be drawn in the drawing area by a-blending, additive a-blending, or subtractive a-blending. R_{Q}, G_{Q}, and B_{Q} are RGB components of the luminance of the image after conversion obtained by a-blending, additive a-blending, or subtractive a-blending.

According to the above-described method, the luminance conversion in which the luminances of all pixels are set to be equal to or greater than a given luminance value while maintaining the contrast of the original image can be easily realized even in a consumer game system which is not provided with a gamma correction circuit or the like. Moreover, since this luminance conversion can be realized by merely drawing a virtual polygon in the drawing area, there is an advantage in which the processing load is extremely low.

In the embodiment, the a-value as the luminance adjustment information is set using the luminance adjustment screen, and the a-blending processing (a-blending, additive a-blending, or subtractive a-blending) as shown in FIGS. 13A to 14B is performed. This enables the luminance of the flash image to be set at a luminance corresponding to the a-value obtained using the luminance adjustment screen, whereby the indication position can be appropriately detected at the time of the flash.

3. Processing According to Embodiment

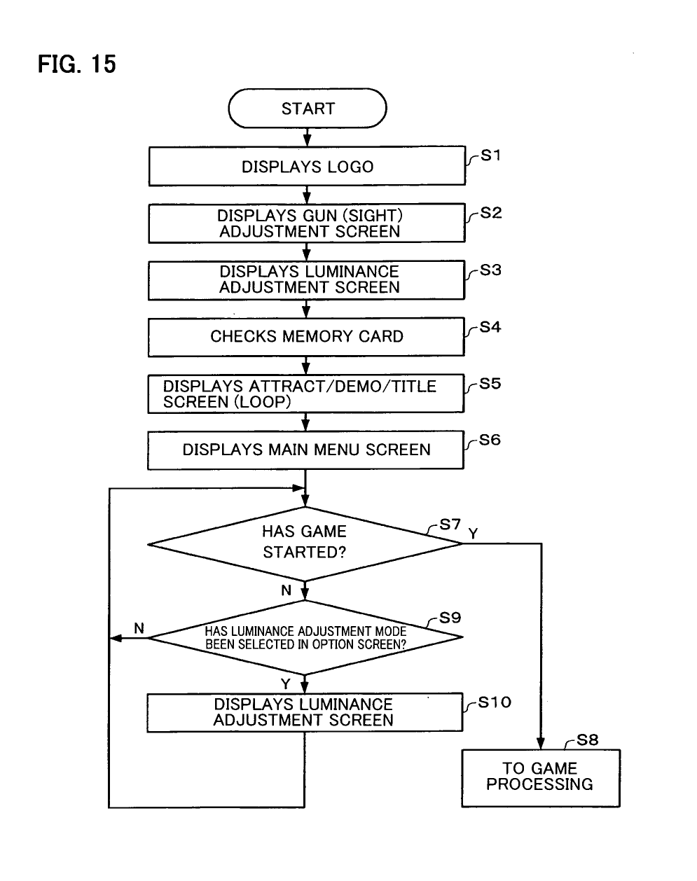

A detailed processing example according to the embodiment is described below using flowcharts shown in FIGS. 15, 16, and 17.

FIG. 15 is a flowchart showing a flow of the entire processing. First, a logo is displayed in the display section (step S1). A gun adjustment screen is then displayed (step S2). The player optimally adjusts the sight of the gun-type controller using the gun adjustment screen. The luminance adjustment screen described with reference to FIGS. 5A and 5B and the like is then displayed (step S3).

A memory card is checked (step S4), and an attract/demo/title screen is displayed (step S5). Then, a main menu screen is displayed (step S6).

Whether or not a game start has been selected by the player is determined (step S7). When the game start has been selected, the game processing is performed (step S8). Then, whether or not the luminance adjustment mode has been selected in the option screen selected in the main menu screen is determined (step S9). When the luminance adjustment mode has been selected, the luminance adjustment screen described with reference to FIGS. 5A and 5B is displayed (step S10).

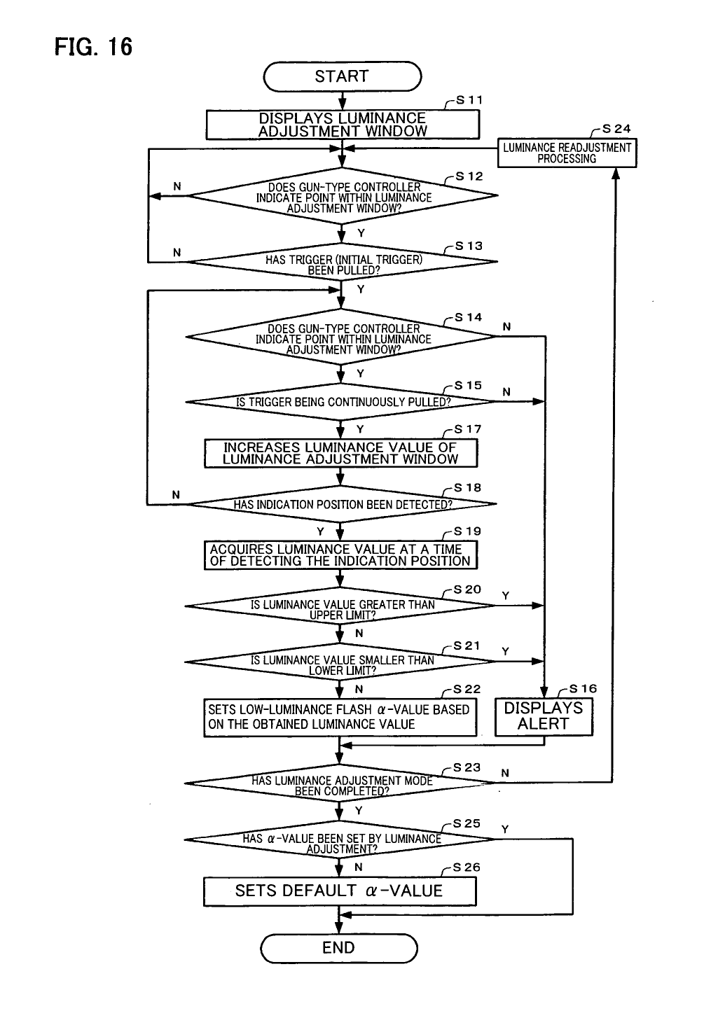

FIG. 16 is a flowchart of the luminance adjustment processing. First, the luminance adjustment window as shown in FIG. 5A is displayed (step S11). Then, whether or not the gun-type controller indicates a point within the luminance adjustment window is determined (step S12). When the gun-type controller indicates a point within the luminance adjustment window, whether or not the trigger (initial trigger) has been pulled is determined (step S13).

When the trigger has been pulled, whether or not the gun-type controller indicates a point within the luminance adjustment window is determined (step S14). When the gun-type controller indicates a point within the luminance adjustment window, whether or not the trigger is being continuously pulled is determined (step S15). When the gun-type controller does not indicate a point within the luminance adjustment window or the trigger is not continuously pulled, the alert as shown in FIG. 6B is displayed (step S16).

When the gun-type controller indicates a point within the luminance adjustment window and the trigger is being continuously pulled, the luminance value of the luminance adjustment window is increased (step S17). Then, whether or not the indication position has been detected is determined (step S18). When the indication position has been detected, the luminance value at the time of detection is acquired (step S19). Then, whether or not the acquired luminance value is greater than the upper limit is determined (step S20). When the acquired luminance value is not greater than the upper limit, whether or not the acquired luminance value is smaller than the lower limit is determined (step S21). When the acquired luminance value is not smaller than the lower limit, the low-luminance flash a-value is set (step S22; see FIGS. 13A to 14B). When the acquired luminance value is greater than the upper limit or smaller than the lower limit, the alert described with reference to FIGS. 7A and 7B is displayed (step S16).

Then, whether or not the luminance adjustment mode has been completed is determined (step S23). When the luminance adjustment mode has not been completed, the luminance readjustment processing is performed (step S24). When the luminance adjustment mode has been completed, whether or not the a-value has been set by the luminance adjustment using the luminance adjustment screen is determined (step S25). When the a-value has not been set, the default a-value is set as the luminance adjustment information (step S26).

There may be a case where the color of the flash screen is caused to differ in production of each weapon, such as generating a flash screen in a first color when a first weapon is selected and generating a flash screen in a second color when a second weapon is selected. In this case, the processing in the steps S14, S15, and S17 may be repeated using the screen in each flash color in order to obtain a luminance value optimum for the flash screen in each color.

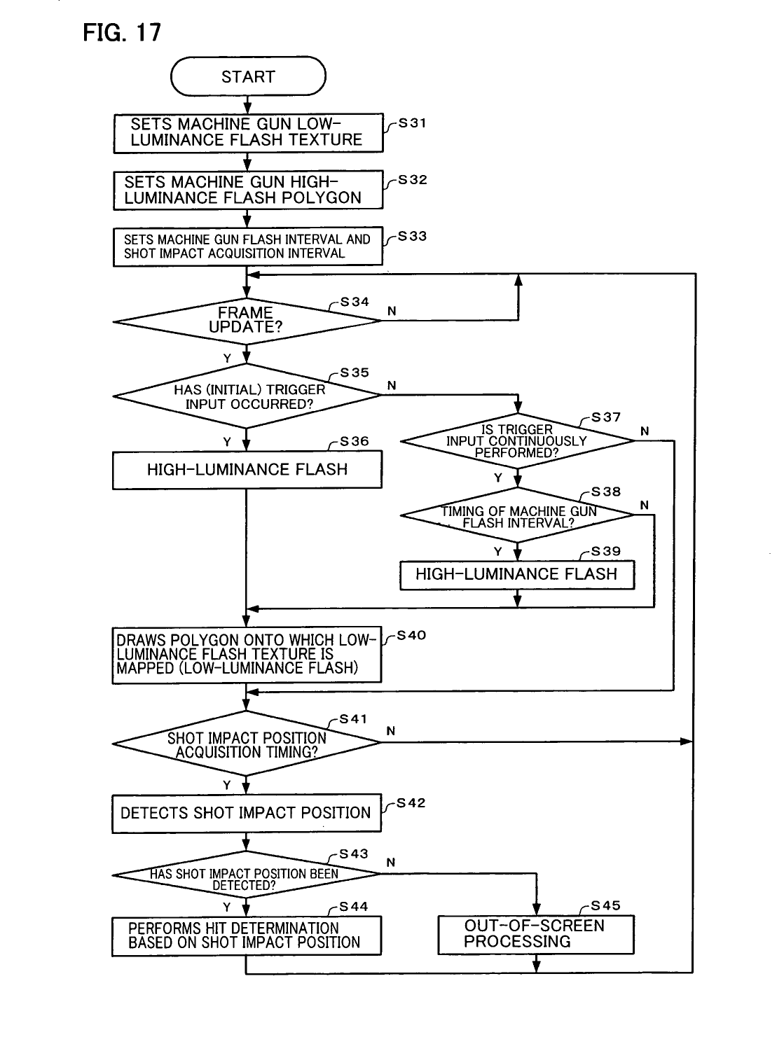

FIG. 17 is a flowchart of flash image generation and shot impact position acquisition processing. First, a machine gun low-luminance flash texture is set (step S31). A machine gun high-luminance flash polygon (white-board polygon) is also set (step S32). Then, a machine gun flash interval and shot impact acquisition interval are set (step S33).

Then, whether or not a frame update occurs is determined (step S34). The frame is a time unit for performing the movement-action processing (simulation processing) of an object or the image generation processing. When the frame update occurs, whether or not an initial trigger input has occurred is determined (step S35). When the initial trigger input has occurred, a high-luminance flash is performed (step S36).

When the trigger input is not the initial trigger input, whether or not the trigger input is continuously performed is determined (step S37). When the trigger input is continuously performed, whether or not the timing of the machine gun flash interval set in the step S33 has been reached is determined (step S38). When the timing of the machine gun flash interval has been reached, a high-luminance flash is performed (step S39).

A low-luminance flash image is generated by drawing a polygon onto which the low-luminance flash texture is mapped using a-blending (step S40). Then, whether or not the shot impact position acquisition timing set in the step S33 has been reached is determined (step S41). When the shot impact position acquisition timing has been reached, the shot impact position is detected (step S42).

Then, whether or not the shot impact position has been detected is determined (step S43). When the shot impact position has been detected, hit determination is performed based on the shot impact position (step S44). When the shot impact position has not been detected, out-of-screen processing which is processing when the virtual bullet hits outside the screen is performed (step S45).

The invention is not limited to the above-described embodiment, and various modifications and variations may be made. For example, the terms (e.g. gun-type controller, shot impact position, and virtual bullet continuous firing operation) cited in the description in the specification or the drawings as the terms in a broad sense or in a similar sense (e.g. pointing device, indication position, and indication position continuous detection operation) may be replaced by the terms in a broad sense or in a similar sense in another description in the specification or the drawings.

A shooting device such as a gun-type controller is preferable as the pointing device used in the invention. However, various pointing devices which can detect the scan light from the display section using a photosensor or the like may be used. For example, the path of a sword or the hit position of a sword may be detected using a pointing device which imitates the shape of a sword using the method of the invention.

The display form of the luminance adjustment screen and the luminance adjustment information setting method using the luminance adjustment screen are not limited to those described in the embodiment, and various modifications and variations may be made. The generation timing of the low-luminance flash image and the high-luminance flash image and the setting method for the low-luminance flash period and the high-luminance flash period are not limited to those described in the embodiment. For example, the high-luminance flash image may be generated either regularly or irregularly. The flash images in three or more luminance stages may be used instead of the flash images in two luminance stages such as the low-luminance flash image and the high-luminance flash image.

The invention may be applied to various games. The invention may be applied to various image generation systems such as an arcade game system, consumer game system, large-scale attraction system in which a number of players participate, simulator, multimedia terminal, system board which generates a game image, and portable telephone.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

What is claimed is:

1. A program product for generating an image, the program product causing a computer to function as:
a flash image generation section which generates a flash image which increases luminance of scan light for detecting an indication position of a pointing device including a photosensor which detects scan light from a display section;
a luminance adjustment processing section which displays a luminance adjustment screen for adjusting luminance of the flash image in the display section, and sets luminance adjustment information of the flash image by luminance adjustment using the luminance adjustment screen; and
an image generation section which generates an image displayed in the display section,
wherein the flash image generation section generates the flash image at a luminance set by the luminance adjustment information.

2. The program product as defined in claim 1,
wherein the luminance adjustment processing section displays a luminance adjustment window in the display section, changes a luminance value of the luminance adjustment window, determines whether or not the indication position of the pointing device is detected in the luminance adjustment window, and sets the luminance adjustment information, based on the luminance value of the luminance adjustment window at a time of detecting the indication position.

3. The program product as defined in claim 2,
wherein the luminance adjustment processing section gradually increases the luminance value of the luminance adjustment window, and sets the luminance adjustment information, based on the luminance value of the luminance adjustment window at a time of detecting the indication position of the pointing device.

4. The program product as defined in claim 2,
wherein the luminance adjustment processing section displays the luminance adjustment window in the display region except an inner circumferential region which is defined as a region along four sides of a screen of the display section and having a given width.

5. The program product as defined in claim 2,
wherein the luminance adjustment processing section displays an alert when the luminance value of the luminance adjustment window, at a time of detecting an indication position of the pointing device, is at least one of greater than a given upper limit and smaller than a given lower limit.

6. The program product as defined in claim 1,
wherein the luminance adjustment processing section sets a default value as the luminance adjustment information when the luminance adjustment information has not been set by the luminance adjustment using the luminance adjustment screen.

7. The program product as defined in claim 1,
wherein the luminance adjustment information is an a-value, and
wherein the flash image generation section generates the flash image by drawing a polygon with a size of a screen or a size dividing the screen in a drawing buffer in which an original image is drawn while performing a-blending.

8. The program product as defined in claim 1,
wherein the luminance adjustment information is an a-value, and
wherein the flash image generation section generates the flash image by drawing a polygon with a size of a screen or a size dividing the screen in a drawing buffer in which an original image is drawn while performing subtractive a-blending in which a negative luminance value is clamped to zero, and drawing a polygon with the size of the screen or the size dividing the screen in the drawing buffer while performing additive a-blending.

9. The program product as defined in claim 1,
wherein the flash image generation section generates a low-luminance flash image in a low-luminance flash period, and generates a high-luminance flash image in a high-luminance flash period.

10. The program product as defined in claim 9,
wherein the flash image generation section generates the low-luminance flash image and the high-luminance flash image so that a luminance difference between the low-luminance flash image and the high-luminance flash image does not change when the luminance adjustment information is changed by adjustment using the luminance adjustment screen.

11. The program product as defined in claim 1, the program product is a product being stored in a computer-readable information storage medium.

12. An image generation system for generating an image, the system comprising:
a flash image generation section which generates a flash image which increases luminance of scan light for detecting an indication position of a pointing device including a photosensor which detects scan light from a display section;
a luminance adjustment processing section which displays a luminance adjustment screen for adjusting luminance of the flash image in the display section, and sets luminance adjustment information of the flash image by luminance adjustment using the luminance adjustment screen; and
an image generation section which generates an image displayed in the display section,
wherein the flash image generation section generates the flash image at a luminance set by the luminance adjustment information.

13. The image generation system as defined in claim 12,
wherein the luminance adjustment processing section displays a luminance adjustment window in the display section, changes a luminance value of the luminance adjustment window, determines whether or not the indication position of the pointing device is detected in the luminance adjustment window, and sets the luminance adjustment information, based on the luminance value of the luminance adjustment window at a time of detecting the indication position.

14. The image generation system as defined in claim 12,
wherein the flash image generation section generates a low-luminance flash image in a low-luminance flash period, and generates a high-luminance flash image in a high-luminance flash period.

15. The image generation system as defined in claim 14,
wherein the flash image generation section generates the low-luminance flash image and the high-luminance flash image so that a luminance difference between the low-luminance flash image and the high-luminance flash image does not change when the luminance adjustment information is changed by adjustment using the luminance adjustment screen.

16. An image generation method for generating an image, the method comprising:
generating a flash image which increases luminance of scan light for detecting an indication position of a pointing device including a photosensor which detects scan light from a display section;
displaying a luminance adjustment screen for adjusting luminance of the flash image in the display section;
setting luminance adjustment information of the flash image by luminance adjustment using the luminance adjustment screen;
generating an image displayed in the display section; and
generating the flash image at a luminance set by the luminance adjustment information.

17. The image generation method as defined in claim 16, further comprising:
displaying a luminance adjustment window in the display section;
changing a luminance value of the luminance adjustment window;
determining whether or not the indication position of the pointing device is detected in the luminance adjustment window; and
setting the luminance adjustment information, based on the luminance value of the luminance adjustment window at a time of detecting the indication position.

18. The image generation method as defined in claim 16, further comprising:
generating a low-luminance flash image in a low-luminance flash period, and generating a high-luminance flash image in a high-luminance flash period.

19. The image generation method as defined in claim 16, further comprising:
generating the low-luminance flash image and the high-luminance flash image so that a luminance difference between the low-luminance flash image and the high-luminance flash image does not change when the luminance adjustment information is changed by adjustment using the luminance adjustment screen.
